(19) United States
(12) Patent Application Publication
(10) Pub. No.: US 2024/0419877 A1
(43) Pub. Date: Dec. 19, 2024

(54) PRE-SILICON POWER ANALYSIS

(71) Applicant: Intel Corporation, Santa Clara, CA (US)

(72) Inventors: John CRESSMAN, Jefferson, MA (US); Gian FRANCISCO, Westford, MA (US); David GRUNDMANN, Westborough, MA (US); Arun SUBBIAH, Folsom, CA (US)

(21) Appl. No.: 18/211,165

(22) Filed: Jun. 16, 2023

(51) Int. Cl. G06F 30/327; G06F 30/31

(52) U.S. Cl. CPC G06F 30/327; G06F 30/31; G06F 2119/06

(57) ABSTRACT

Provided is a power estimation tool for estimating power from an RTL simulation waveform. The tool may use an inference engine that uses an ML trained power estimation model.

### TECHNICAL FIELD

Embodiments relate to the field of electrical design automation (EDA) for integrated circuit devices; and more specifically, to analyzing power for logical partition simulations.

### BRIEF DESCRIPTION OF THE DRAWINGS

FIG. 1 illustrates an integrated circuit electrical design automation flow diagram in accordance with some embodiments.

FIG. 2 is a diagram conceptually illustrating how a digital design may be transformed into partitions for RTL level analysis in accordance with some embodiments.

FIG. 3 is a flow diagram illustrating a process for analyzing RTL simulation power in accordance with some embodiments.

FIGS. 4A-4C are diagrams conceptually illustrating how a hyper-window array may be generated in accordance with some embodiments.

FIG. 5 is a data flow diagram showing how a model for an ML based power estimation tool may be generated in accordance with some embodiments.

FIGS. 6A-6B are diagrams conceptually illustrating how a power estimation tool may generate power estimates from one or more RTL simulation files in accordance with some embodiments.

FIG. 7A is a flow diagram illustrating how a power analysis tool using a power estimation inference engine may be implemented in accordance with some embodiments.

FIG. 7B is a graph illustrating an example of how a power estimation system may be used to more effectively analyze power for an RTL partition simulation in accordance with some embodiments.

FIG. 8 is a block diagram showing a computing system that may be used for running power estimation tools in accordance with some embodiments.

### DETAILED DESCRIPTION

Digital IC design is a procedural process that involves converting specifications and features into digital blocks and then further into logic circuits. Design skill and ingenuity are key at the higher-level stages of digital IC design and the development of systems and processes to ensure a design meets specification objectives as efficiently as possible.

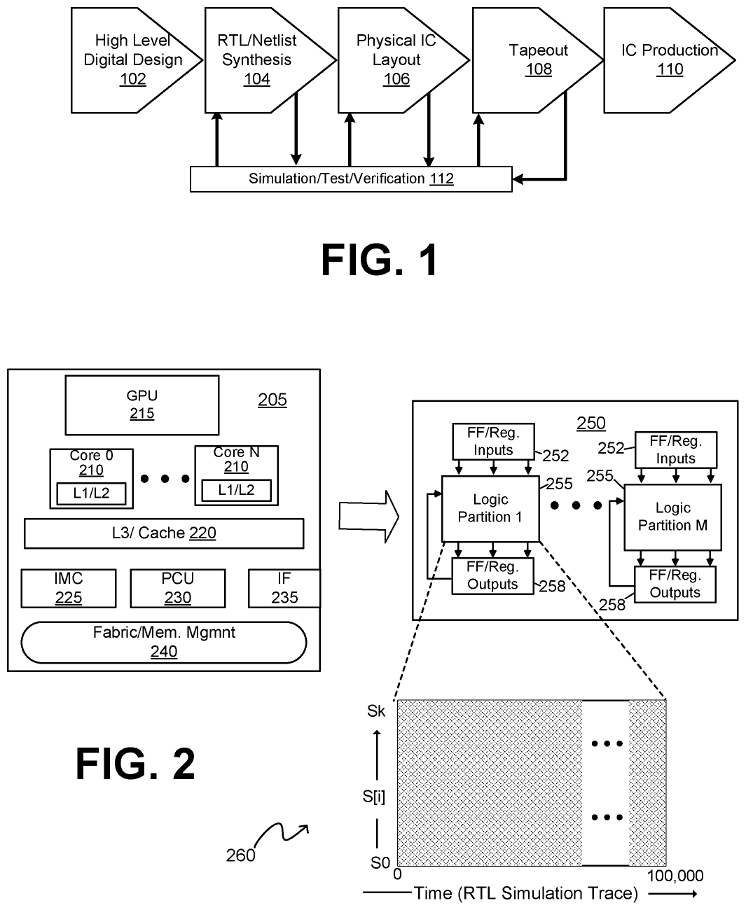

FIG. 1 is a diagram illustrating at a high level a typical design flow for a digital integrated circuit (IC). It generally begins with a high-level functional design 102. This involves defining functional operations, at system and sub-system levels, along with other parameters such as operational performance, resource constraints, and reliability.

An RTL/netlist stage (104) comes next. This involves translating the digital blocks with behavior descriptions developed in the early design phase 102 into a hardware description language (HDL), such as Verilog or VHDL. This phase is often called the Register Transfer level (RTL) phase, which generally includes functional verification to ensure that the logic implementation meets specification parameters at a high-level. After this step, the hardware description is then converted into a gate-level netlist, during which a variety of implementations and optimization routines may be tried to better meet design goals. Important considerations at this stage include power budget, speed, footprint, and reliability. Along these lines, some embodiments disclosed herein may be employed to improve the design process by facilitating efficient power analysis within this stage.

Next, at 106, physical IC layout typically occurs. Here, the gate-level netlist is transformed into physical layout, which is a geometric representation of the layers and physical structure of the integrated circuit. Floor-planning methods are employed to ensure placement of the blocks and pads throughout the IC meet design goals. Due to the structured and repetitive nature of some digital blocks, such as memory and registers, portions of digital IC layout are often done using scripts and automated software processes. External IP cores may also be placed during this stage, where the necessary interface portions of the IP are revealed by the software. After blocks and gates are positioned, along with manual routing if necessary, routing automation scripts and software may then be used to connect the elements.

At 108, the design is ready for tapeout. Verification and simulation are performed, both of which taking into account the placement and physical features of the layout. If successful, the result is an output file, such as GDSII (Graphic Design System II) format, which a foundry can then use to fabricate the IC for the tape-out stage. Usually, the foundry will discover issues with the design that then need to be corrected by the design team. After tape-out, a small batch of first-run or prototype ICs are typically produced so that testing can be performed. This testing may result in redesign or process changes depending on the performance and economics of producing the IC. Once test results are satisfactory, the IC can then go into mass production as represented at 110.

Note that as shown at 112, along and within each of these design stages, simulation, verification, testing, and re-design (SVTR) can, and normally will, occur. In fact, overall design flows are greatly improved with enhanced SVTR processes, especially when they are performed well in the earlier design stages. With particular relevance to the present disclosure, accurate and convenient power analysis at the RTL/netlist phase will greatly benefit downstream results. In analyzing RTL design phase simulations for power, it has traditionally been a challenge to identify accurate, representative power test windows. Poor selections have delayed accurate pre tapeout power estimates until later in design execution cycles. Worse yet, power results based on incorrect power test windows can go undetected until signoff at the end of the RTL/netlist stage, resulting in delay and post tapeout miscorrelation with pre tapeout power calculations.

Accordingly, in some embodiments, this challenge may be addressed by applying a technique dividing RTL simulation traces into windows and using them to generate a machine learning (ML) model, which can then be used to more conveniently and accurately analyze operational power by, among other things, identifying more reflective RTL simulation windows of operation for power analysis. In addition, embodiments may be used to identify key signals with higher influences in generating power. With use of such a model for predicting power throughout a simulation trace, unexpected power events, as well as the conditions leading to them, may also be identified.

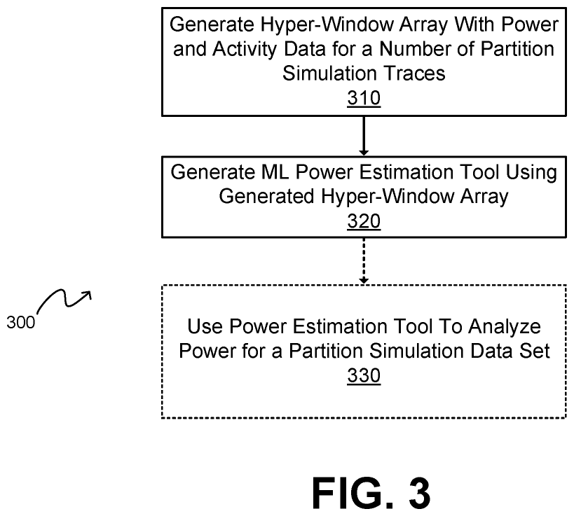

FIG. 2 is a conceptual diagram illustrating how a digital IC design may be transformed into an HDL (e.g., Verilog or VHDL) RTL form using partitioning. At a high design stage level, a processor 205, for example, may have numerous functional blocks such as CPU cores 210, a GPU 215, L3 cache block 220, integrated memory controller (IMC) 225, power control unit (PCU) 230, and fabric and memory management system 240. In order to express them in a register transfer language (RTL) form, they first may be parsed into a block 250 of logical partitions 255 with associated register/flip-flop (FF) inputs 252 and signal capturing registers/FFs 258. The logical partitions may or may not directly correspond to the functional blocks. That is, they may have overlapping (shared) components for modeling the different partition inputs, outputs and sequentials, and multiple partitions may be used to facilitate one or more of the functional blocks.

In order to analyze and verify the functional operation of a partition, the RTL (e.g., Verilog or VHDL) model may be simulated using a suitable simulation system. Many designers use off-the-shelf system such as a Synopsys, Inc. VCS™ product, or they may modify such a system and/or create their own. For purposes of this disclosure, either approach may be fine. Simulations are typically run using a variety of workload scenarios with different input signal vectors and conditions over a period of time, which may correspond to actual time (e.g., in picoseconds) or to block cycles, e.g., cycles of a clock present in the functional block under test. A simulation run will typically generate a resultant waveform, which may be captured in a waveform file that can be used for later detailed analysis. There are several different waveform file formats used today including, for example, WLF (Wave Log File), VCD (Value Change Dump), FSDB (Fast Signal Data Base). (It should be appreciated that as a matter of convenience, FSDB may be used for presenting the various concepts disclosed herein but any suitable platforms or platform formats may be used.)

With reference to FIG. 2, a conceptual example of a functional RTL simulation waveform file 260 is shown. For ease of explanation, here, and throughout the disclosure, it may be assumed this is an FSDB waveform file. The file essentially is an array of digital signal values (0 or 1) for k different signals within the partition over a range of time units, e.g., over a range of 100K or more clock cycles. The time unit, of course, is an adjustable simulation run parameter.

The signals (S [i]) may be referred to as a partition signal vector, including k different signals for the partition under test. The value of k may be very large, depending on the complexity and size of the logical partition and corresponding functional block being simulated. For example, a signal vector S [i] could include thousands of different signals such as clocks, enable signals for various logical elements, flop/register data (rd/wr) and address lines, combinational gate data inputs/outputs, other control lines, and the like. The signal vector, where appropriate, would typically be loaded with signal values to cause a desired workload to be processed and simulated with the simulator generating the resultant waveform file for that workload. When analyzing a simulation, a user might look for specific signal vector states, i.e., one or more of the specific signals being at certain values, corresponding to certain events, or operations, of interest. For example, a designer may wish to observe simulation parameters during a floating point multiplication operation within a certain block or a read or write operation for certain cache or register array slices. With some embodiments, a power estimation engine may make such analysis convenient for assessing power related parameters for such operations of interest.

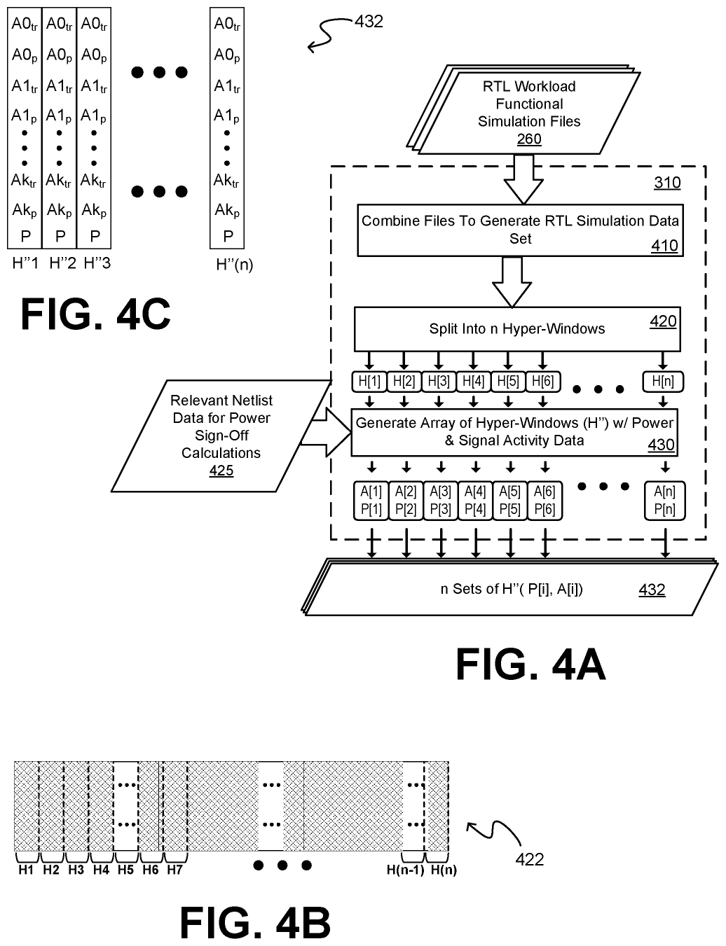

FIG. 3 is a flow diagram showing a power estimation method 300 in accordance with some embodiments. At 310, a hyper-window array with power and signal activity data is generated from an RTL partition simulation. This full RTL partition simulation is generated from the logic and functional validation of the RTL description of the partition and exercises the different functional components which make up the partition. The array may incorporate data from one or more simulation traces that are combined and split into multiple timeframe windows. The activity data, for example, may include calculated toggle rate (tr) and duty cycle (or static probability) data for some or all of the signals in a signal vector. The power may be calculated for each window using conventional power sign-off techniques. The one or more simulation traces, which make up the array, may correspond to a very large number of simulation time units, e.g., 300K or more. The hyper-window time width may be any suitable size, although it should be short enough (e.g., 2000-5000 time units) to provide enough granularity for analysis to be able to capture power information for activity events of interest as well as long enough (at least a full clock cycle) to include sufficient context of power events.

At 320, an ML power estimation tool is then generated using the hyper-window array. The array of power and signal activity data is used to train a machine learning power estimation model for the partition under test. Conventional ML techniques such as well-known Python library methods may be used for generating this model. In addition, the model may be used to identify key activity signals or signal combinations that disproportionately affect power for the partition.

At 330, the power prediction engine may then be used to estimate power for simulation traces for that same partition. In addition, an analysis (or with filter/search functionality) interface may be incorporated to allow users to identify power activity of interest associated with the partition. For example, a designer may be able to more accurately determine when and how a workload may vary across windows that otherwise might not be observed when looking only at expected power hungry signal activity scenarios. From here, a designer could, for example, look further into identified high power windows that may have previously been missed or debug how activity operations may be executed differently than had been expected.

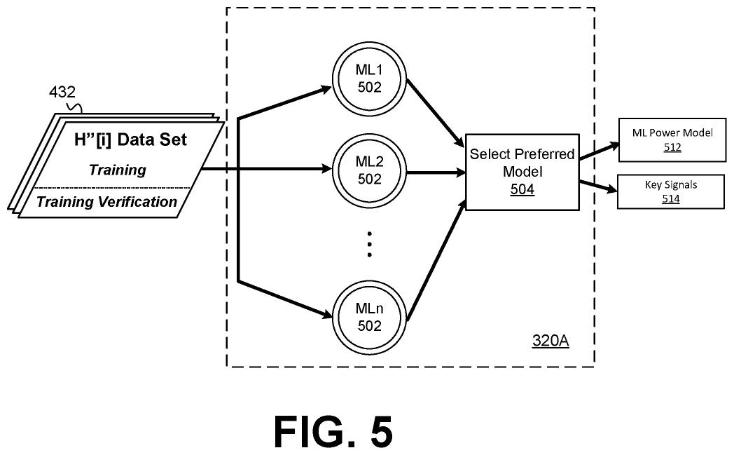

FIGS. 4A-4C are diagrams conceptually illustrating how a hyper-window array may be generated at 310 in accordance with some embodiments. Initially, one or more RTL simulation trace files 260 are read in and combined (e.g., concatenated) at 410 to form a resultant RTL partition data set.

At 420, the data set is split sequentially into a set of n windows, which are represented at 422 in FIG. 4B. The windows are referred to as hyper-windows since the overall data set may be broken into a large number of relatively small window timeframes. For example, a data set could include over 300,000 cycles of signal vector simulation (e.g., FSDB) data, which might be split into windows each including 500 to 2000 or so cycles. The windows are labeled as “H [i]”, where I is a value between 1 and n. (Note that an “H”, without any apostrophes, is used to connote a data set of raw simulation data windows, i.e., not necessarily including power or calculated signal activity data for the windows. On the other hand, as used throughout this disclosure, an “H” having a single apostrophe (“H'”), is used to connote a data set of windows having calculated activity data for each window but not necessarily having power data. In turn, an “H” having a double apostrophe (“H''”) is used to connote a data set of windows having both calculated activity data and power data for each window.)

At 430, an array, or data set, of hyper windows (H″[i]) having power and calculated signal activity data is generated. In some embodiments, for each window, the calculated signal activity may include a toggle rate and a duty cycle (or probability) value for each signal in the signal vector. Toggle rate (tr) is the average switching rate for the signal over the window timeframe, while static probability (p), also referred to as duty cycle, is the percentage of cycles within a window where the signal is at a '1.

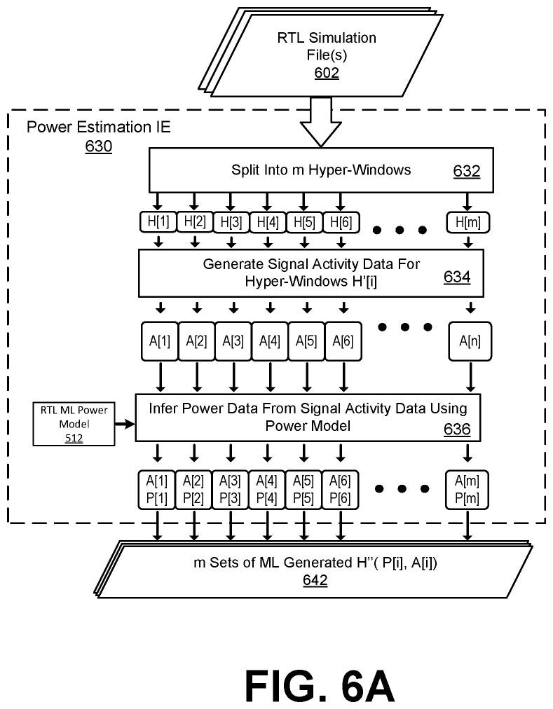

In order to calculate power for each window, a hyper-window's simulation activity data is applied to a routed layout netlist including parasitic R/C parameters using a conventional power sign-off methodology. For example, in some embodiments, RTL power sign-off tools such as PrimePower™ from Synopsys Inc. or Joules™ from Cadence Design Systems Inc. could be used to generate power data for each window from corresponding RTL signal vector activity data and physical gate netlist parameters. In some embodiments, such a power sign-off tool may be used to derive an average dynamic power (including power from devices and routing) for each hyper window (H″[i]). FIG. 4C shows a representation of an array (or data set) 432 of such hyper windows (H″[i])) having calculated activity data (A [i]ₜᵣ, A [i]ₚ) and power data (P). FIG. 5 is a data flow diagram showing how a model 512 for an ML based power

estimation tool may be generated in accordance with some embodiments. The set of power (P) and activity (Aₜᵣ, Aₚ) data (referred to as A&P data), are provided to a plurality of different ML model training engines 502. They are used to generate, in parallel, a power estimation model for each of the ML methods. The activity data are treated as features, and the power data are treated as the targets for the ML models to be generated. In some embodiments, various different ML algorithms such as Linear Regressor, Random Forest, Multilayer Perceptron, Decision Tree, KNearest Neighbor, Model N, Model N-1, and Neural Network, among others, may be used for the ML model builders 502. A majority of the A&P data is used for training, i.e., building the models, while the remaining portion may be used to test the models to assess their accuracy against actual sign-off estimates used as controls. For example, 70% of the windows may be used for training with the remaining 30% used for testing and verification.

At 504, a preferred model, e.g., the most accurate model as compared against a power sign-off control, is selected. In some embodiments, it has been found that Random Forest and Linear Regressor model building methods have provided preferred models. The result of this ML training and verification 320A is an ML power estimation model 512 and a list of feature importance 514, signals or signal combinations that have the most influence on power as identified by the model. For example, many ML training tools allow a user to see a list of features with corresponding weights relating to their influence on the target, in this case, power. The feature importance derived from the ML model enables a user to identify key signals that are the most highly correlated to the power dissipation level. This list of key signals may also be used as a check to identify missing user defined signals for frequency and duty cycle requirement checks.

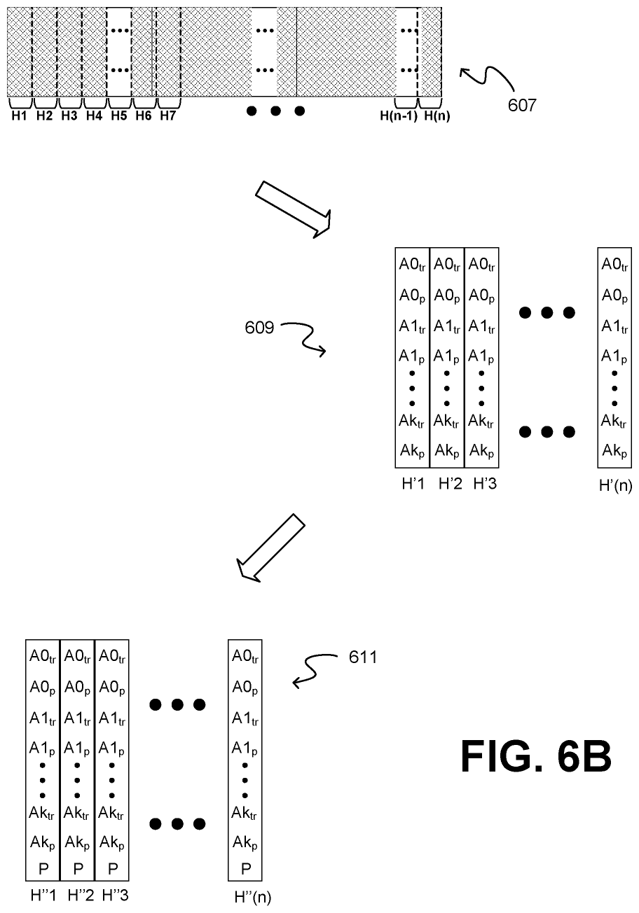

FIGS. 6A-6B are diagrams conceptually illustrating how a power estimation tool may generate power estimates from one or more RTL simulation files 602 in accordance with some embodiments. Initially, at 632, the files are combined, if necessary, and split into m hyper windows. This may be done in the same manner as with the training hyper-windows in that they may have the same window width, although this is not necessary. Here, however, m windows may be created, recognizing that this value will typically be different from and most likely, much smaller than, the value n used for the training data set. With reference to FIG. 6B, such windows (H [i]) are illustrated at 607.

At 634, as represented at 609 in FIG. 6B, activity data (A [i]) for toggle rate and probability (duty cycle) are generated for each of the hyper windows (H′ [i]). In most cases, the same signal vector (S [i]) used for training will be used for the activity vector (A [i] under test here. Finally, at 636, the power values for each hyper window are generated using an inference engine having a power model 512 previously generated. This is represented at 611 in FIG. 6B resulting in m windows of activity and power data as shown at 642.

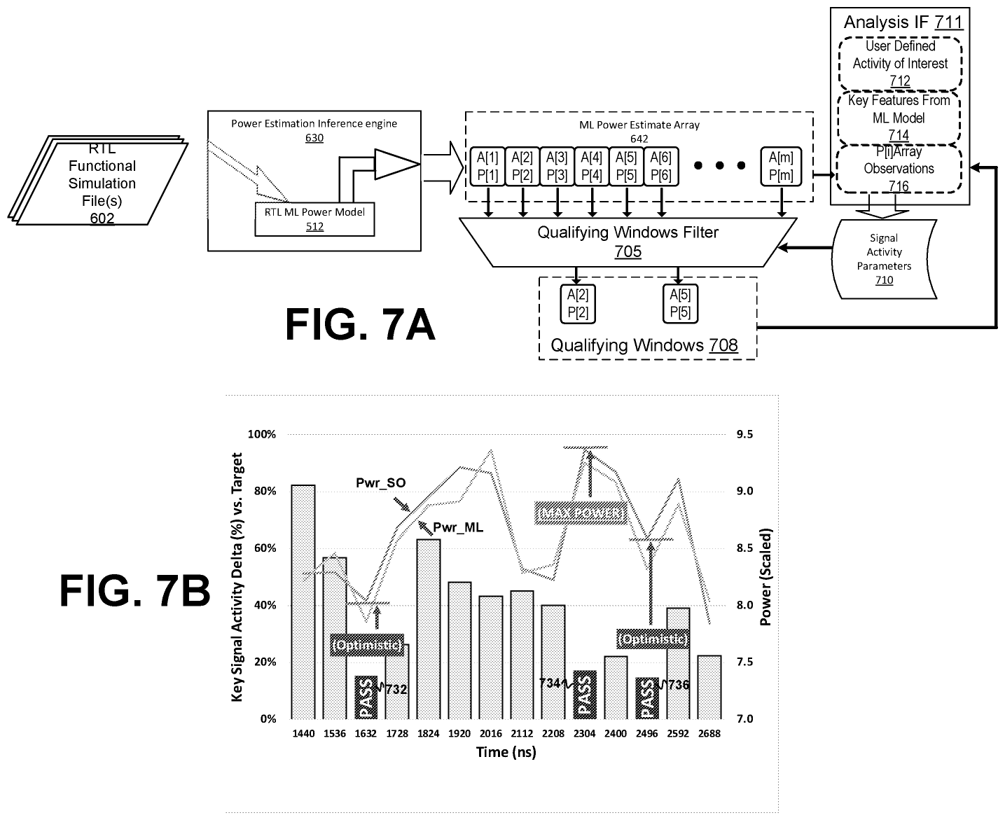

FIG. 7A is a flow diagram illustrating how a power analysis tool using a power estimation inference engine 630 may be implemented in accordance with some embodiments. A simulation file, or files, 602 are input into the power estimation engine 630, which in turn, as described above, generates an array 642 of windows with power and activity data. The analysis system includes a qualifying windows filter 705, which may be implemented with search and/or other data engineering techniques to identify windows that satisfy signal activity parameters 710 applied to the filter.

A user or processing module may define the activity parameters through analysis interface 711 based on several different interface options 712, 714, and/or 716. At 712, a user could define specific signal activity parameters (A [i]ₜᵣ, A [i]p . . . ) corresponding to particular operations or events of interest. For example, a user might be interested in a signal or signal combination corresponding to a particular logical action (e.g., mathematical action, read/write, global/local clk toggle rate, etc.) or logical block being active and/or operating at a maximum performance state. At 714, the parameters could also come from key activity signals 514 identified from the generated model 512. At 716, observations from the estimated power results themselves could be used to inform, or further inform, the parameter specification. This interface 711 may be convenient for a user (or analysis engine) to analyze power versus activity based on any number of different use cases, defining and re-defining parameter criteria as desired.

FIG. 7B is a graph illustrating an example of how a power estimation system could be used to more effectively analyze power for an RTL partition simulation trace. Note that not only does this allow designers to more effectively identify power characteristics for the partition, but also, they don't have to go through the sometimes tedious step of running the sign-off power process, instead, needing only the RTL functional simulation trace and the power model inference system such as has been described herein.

The graph of FIG. 7B is actually two separate graphs overlaying one another. The first is a bar chart where each bar represents a hyper window with the height corresponding to how far away its activity parameters are from a specified parameter request, e.g., as defined at 710 in FIG. 7A. Thus, the lower the bars, the closer the window's activity values are to the specified requested values. In this example, three of the windows “passed”, their activity signal values being close enough to the specified criteria from 710.

The other graph shows two curves, labeled Pwr_SO and Pwr_ML, representing estimated power from a netlist process and from an ML power model, respectively, the latter being derived in accordance with embodiments described herein. It can be seen that the ML derived power estimates are very close to those obtained using the traditional, more resource-intensive netlist parameter process. (Note that under normal use, a power estimation engine, as discussed herein, would likely not generate the sign-off curve, one of its benefits being that this can be avoided with the use of the ML inference tool. However, this curve was included here to show how accurate an ML derived curve may be in accordance with embodiments described herein.) This example also shows how unexpected higher power scenarios may be detected that otherwise might have been missed. A designer might think that activities satisfying the requested parameter criteria should consume close to the same power, but using the power inference via ML model in this example, it is revealed that one of the activity windows (middle one) consumes much more power than the other two windows. From here, the user could look further into the window by examining other signals from the generated H″[i] array or by using the interface 711 to see the most influential signals other than those used to define the initial specified activity parameters from 710. It can be seen that this tool may be used in a variety of ways to improve power analysis and redress design issues or enhance design features more effectively earlier in the IC design flow process.

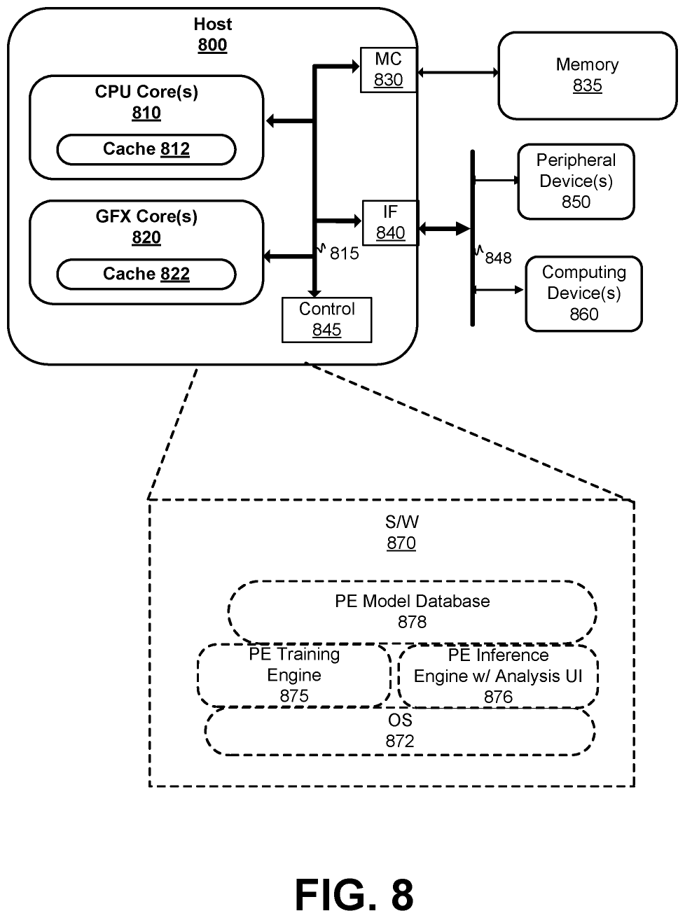

FIG. 8 is a block diagram showing a computing system that may be used for running the various power estimation and analysis tools described herein. The system generally includes a host processing device 800, which is coupled to external memory 835 and to peripheral devices 850, as well as to other computing devices 860 through interface 848. Interface 848 may be implemented with a combination of one or more point-to-point links, busses, or fabrics and may include multiple networks linking the host to the peripheral devices and to the other computing devices. The system also includes software 870, some or all of which may be stored and run within the depicted system.

The memory 835 may include any suitable memory such as DRAM and/or non-volatile memory systems such as memory servers, solid-state drives and portable memory such as flash drives. The peripheral devices 850 correspond to user interface devices such as displays, keyboards, headsets, and the like.

The host processing device 800 may be implemented with one or more integrated circuits in the same or in multiple packages. It generally includes CPU cores 810 with associated cache 812, graphics processing cores 820 with their associated cache 822, a fabric interconnect system 815, memory controller 830, interface controller 840, and control/Memory block 845, which may encompass various different functional blocks such as low-level shared cache, security management, fabric control, power management, and/or special purpose blocks, chips and/or modules such as ASIC or FPGA assemblies for carrying out various specialized functions.

The software 870 includes an operating system 872, a power estimation training engine 875, as described herein, power estimation inference engine with analysis interface 876, as described herein, and a power model database for housing trained power models for different IC designs and different partitions within those designs. This software could be stored, when not running, wholly or partially, in external host memory 835 or across different storage devices capable of being linked with host 800. Similarly, when running, apart from the OS 872, some or all of the other components could be executed by the host processing device 800, itself, or together by host processing device 800 and other computing devices 860 in a distributed fashion and not necessarily at the same time.

The computing devices 860 include any suitable computing device that can operate apart from, in concert with, or in support of the host processing device 800. For example, a computing device could be a supporting device such as a co-processor, a GPU card, an accelerator, or a special function module such as an FPGA or ASIC module designed for special-purpose processing such as network or AI processing. The computer devices can also include stand-alone devices such as mobile devices, personal computers, server systems, datacenter systems, and the like. It will be appreciated that with many IC design processes, many different design, modeling, simulation, and verification tools may be implemented in one, some or many different computing systems that may or may not be interconnected to one another. For example, it is typical for different design teams to work on their aspects of IC EDA and thus, they may use tools running in different computing systems at different times with files being shared, handed off, returned, modified, reviewed, further processed, etc. Accordingly, embodiments of the methods and physical features described herein may be implemented in many different ways using a variety of computing systems and disaggregated work-flow schemes and thus, the inventive embodiments are not limited to any particular scheme.

Illustrative examples of the technologies disclosed herein are provided below. An embodiment of the technologies may include any one or more, and any compatible combination of, the examples described below.

Example 1 is a method that includes, for an integrated circuit partition, dividing one or more RTL simulation waveform files into a plurality of windows. It also includes processing the windows to generate activity and power values for each window. In addition, an ML generated power estimation model for the partition is created using the processed windows.

Example 2 includes the subject matter of Example 1, and wherein processing includes calculating an average toggle rate for signals in the simulation for each window.

Example 3 includes the subject matter of any of claims 1-2, and wherein processing includes calculating an average duty cycle value for the signals in the simulation for each window.

Example 4 includes the subject matter of any of claims 1-3, and wherein the power values are generated from average power sign-=off data from each window.

Example 5 includes the subject matter of any of claims 1-4, and wherein creating the ML generated power estimation model includes training activity values as features and the power as a target in a linear regressor ML training process.

Example 6 includes the subject matter of any of claims 1-5, and further comprising estimating power for a simulation trace of the partition using the generated model, the estimated power to be applied in designing a logic block of an integrated circuit.

Example 7 includes the subject matter of any of claims 1-6, and wherein estimating power includes identifying windows having specified activity criteria.

Example 8 includes the subject matter of any of claims 1-7, and wherein the identified windows are examined to identify windows consuming the highest power.

Example 9 is a computer readable storage medium having instructions that when executed perform a method as recited in any one of the preceding examples.

Example 10 is a computer system that includes at least one processor and memory. The memory has instructions that when executed by the at least one processor divide a data set of RTL functional simulation data for a logical partition into n windows. The executing instructions also generate activity and power data for each of the windows, and provide a first portion of the generated activity and power data to an ML training engine to create a power estimation model.

Example 11 includes the subject matter of example 10, and wherein the instructions include instructions that when executed provide a remaining portion of the generated power and activity data to test the model.

Example 12 includes the subject matter of any of examples 10-11, and wherein the first portion of the generated activity and power data is provided to a plurality of different ML training engines to generate a plurality of power estimation models, and wherein the remaining portion of the generated power and activity data is applied to test the models to identify a preferred model.

Example 13 includes the subject matter of any of examples 10-12, and wherein the plurality of ML training engines include linear regressor and random forest ML training engines.

Example 14 includes the subject matter of any of examples 10-13, and wherein the data set comprises multiple traces of functional simulation waveform files.

Example 15 includes the subject matter of any of examples 10-14, and wherein generating activity data includes determining an average toggle rate value for partition signals in each window.

Example 16 includes the subject matter of any of examples 10-15, and wherein generating activity data includes determining an average duty cycle value for the partition signals in each window.

Example 17 includes the subject matter of any of examples 10-16, and wherein the memory has inference engine instructions that when executed infer power estimation values using the generated model for windows of an input simulation trace for the partition.

Example 18 includes the subject matter of any of examples 10-17, and further comprising a user interface to receive activity parameters for the trace and identify windows satisfying the activity parameters.

Example 19 includes the subject matter of any of examples 10-18, and further comprising a user interface to provide to a user a list of signals for the partition and an indication of their relative importance in influencing power consumption.

Example 20 is a computer readable storage medium having instructions to facilitate a power estimation tool. The tool includes an ML-generated power estimation model and an inference engine. The inference engine infers power for each window of an applied simulation data set that includes activity data for each window. To do this, the inference engine uses the power estimation model to infer the power.

Example 21 includes the subject matter of example 20, and wherein the tool includes an analysis interface to allow a user to specify activity criteria and return to the user power information for windows whose activities satisfy the specified parameters.

Example 22 includes the subject matter of examples 20-21, and wherein the analysis interface provides a list of partition signals with indications of their importance in affecting power.

Example 23 includes the subject matter of example 20-22, and wherein the inference engine can infer power for each window without physical netlist parameter data.

Example 24 includes the subject matter of examples 20-23, and wherein the power estimation model is a linear regressor generated ML model.

Example 25 is an integrated circuit having logical blocks formed from RTL partitions. At least some of the partitions are validated for power consumption using an ML generated power estimation tool.

Example 26 includes the subject matter of example 25, and wherein the ML generated power estimation tool includes a power estimation model for each of the some of the RTL partitions.

Example 27 includes the subject matter of any of examples 25-26, and wherein each power estimation model is generated from training data including activity data for simulation data windows for simulation traces of an associated partition.

Example 28 includes the subject matter of any of examples 25-27, and wherein the activity data includes signal vector toggle rate averages.

Example 29 includes the subject matter of any of examples 25-28, and wherein the activity data includes signal vector duty cycle averages.

As used in this specification, the term “embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. Different circuits or modules may share ore even consist of common components. for example, A controller circuit may be a circuit to perform a first function and at the same time, the same controller circuit may also be a circuit to perform another function, related or not related to the first function.

The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

A circuit design processed as described herein may be implemented within an IC. In one or more embodiments, the circuit design may be processed by a system to generate a configuration bitstream that may be loaded into an IC to physically implement the circuitry described by the processed circuit design within the IC.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “output” means storing in physical memory elements, e.g., devices, writing to display or other peripheral output device, sending or transmitting to another system, exporting, or the like.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth.

A computer program product may include a computer readable storage medium (or media) having computer readable program instructions thereon for causing a processor to carry out aspects of the inventive arrangements described herein. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object oriented programming language and/or procedural programming languages. Computer readable program instructions may include state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The corresponding structures, materials, acts, and equivalents of all means or step plus function elements that may be found in the claims below are intended to include any structure, material, or act for performing the function in combination with other claimed elements as specifically claimed.

What is claimed is:

1. A method comprising:
for an integrated circuit partition, dividing one or more RTL (register transfer level) simulation waveform files into a plurality of windows;
processing the windows to generate activity and power values for each window; and
creating an ML (machine learning) generated power estimation model for the partition using the processed windows.

2. The method of claim 1, wherein processing includes calculating an average toggle rate for signals in the simulation for each window.

3. The method of claim 1, wherein processing includes calculating an average duty cycle value for the signals in the simulation for each window.

4. The method of claim 1, wherein the power values are generated from average power sign-off data from each window.

5. The method of claim 1, wherein creating the ML generated power estimation model includes training activity values as features and the power as a target in a linear regressor ML training process.

6. The method of claim 1, comprising estimating power for a simulation trace of the partition using the generated model, the estimated power to be applied in designing a logic block of an integrated circuit.

7. The method of claim 6, wherein estimating power includes identifying windows having specified activity criteria.

8. The method of claim 7, wherein the identified windows are examined to identify windows consuming the highest power.

9. A computer readable storage medium having instructions that when executed perform a method as recited in any one of claims 1-8.

10. A computer system, comprising:
at least one processor; and
memory having instructions that when executed by the at least one processor:
divide a data set of RTL (register transfer level) functional simulation data for a logical partition into n windows;
generate activity and power data for each of the windows; and
provide a first portion of the generated activity and power data to an ML (machine learning) training engine to create a power estimation model.

11. The computer system of claim 10, wherein the instructions include instructions that when executed provide a remaining portion of the generated power and activity data to test the model.

12. The computer system of claim 10, wherein the first portion of the generated activity and power data is provided to a plurality of different ML training engines to generate a plurality of power estimation models, and wherein the remaining portion of the generated power and activity data is applied to test the models to identify a preferred model.

13. The computer system of claim 12, wherein the plurality of ML training engines includes linear regressor and random forest ML training engines.

14. The computer system of claim 10, wherein generating activity data includes determining an average toggle rate value for partition signals in each window.

15. The computer system of claim 14, wherein generating activity data includes determining an average duty cycle value for the partition signals in each window.

16. The computer system of claim 10, wherein the memory has inference engine instructions that when executed infer power estimation values using the generated model for windows of an input simulation trace for the partition.

17. The computer system of claim 16, comprising a user interface to receive activity parameters for the trace and identify windows satisfying the activity parameters.

18. The computer system of claim 16, comprising a user interface to provide to a user a list of signals for the partition and an indication of their relative importance in influencing power consumption.

19. A computer readable storage medium having instructions to facilitate a power estimation tool, comprising:
an ML (machine learning)-generated power estimation model; and
an inference engine to infer power for each window of an applied simulation data set that includes activity data for each window, the inference engine to use the power estimation model to infer the power.

20. The storage medium of claim 19, wherein the tool includes an analysis interface to allow a user to specify activity criteria and return to the user power information for windows whose activities satisfy the specified parameters.
